(19) United States
(12) Patent Application Publication
(10) Pub. No.: US 2022/0243870 A1
(43) Pub. Date: Aug. 4, 2022

(54) Device Mount

(71) Applicant: Troy Hafeez Balewa, Tempe, AZ (US)

(72) Inventor: Troy Hafeez Balewa, Tempe, AZ (US)

(21) Appl. No.: 17/162,111

(22) Filed: Jan. 29, 2021

(51) Int. Cl. F16M 13/04; A01K 29/00; F16M 11/04

(52) U.S. Cl. CPC F16M 13/04; F16M 11/041; A01K 29/005

(57) ABSTRACT

An apparatus for holding a portable electronic device, such as a cellular phone, smart phone, camera, or other digital media device, that may be strapped or otherwise secured to an animal's head, such as a dog. A first and second parallel strap systems, connected by a central square or rectangular pad, and having a plurality of inner facing and complimentary loops on the inner side of the first and second parallel straps, providing for one or more adjustable perpendicular straps. The top surface of the central square or rectangular pad is further comprised of an attached mount which provides connection means for attaching an electronic device such as a camera or smartphone. The inner facing complimentary loops on each opposing parallel strap provide adjustment means making the device adaptable to a variety of sizes and to provide better fitment.

### SEQUENCE LISTING OR PROGRAM

Not Applicable

### TECHNICAL FIELD OF THE INVENTION

The present invention generally relates to a specialty device mount for electronic devices that have video-recording capabilities. More particularly, the invention relates to an apparatus for holding a portable electronic device, such as a cellular phone, smart phone, camera, or other digital media device, that may be strapped or otherwise secured to an animal's head, such as a dog.

### BACKGROUND OF THE INVENTION

Many devices are known in the prior art for mounting cameras to animals and pets, whether that be for military or commercial applications or home and personal use.

In military and commercial applications, trained animals, and especially canines are used for many tasks. With the proliferation of light, multi-function electronic devices such as smartphones and cameras, such devices are being used more than ever.

Additionally, the explosion of social media and platforms for home audio and video content such as YOUTUBE have created a large demand for recording massive amounts of digital content from various personal perspectives such as animals.

Many of the prior art mounting devices as based on older, heavier electronic devices which were/are commonly mounted on the chest and back of an animal, especially a four-legged email such as a canine. Chest/back mounted cameras allow for more weight to be carried and better mount stability but limit the field of vision of a mounted camera to that of the back of an animal and not the exact following of an animal's eyes, nose, and mouth, which may be particularly interesting to content creators or in commercial or military applications.

The Inventor, as an active individual with a pet German Shepherd dog who partakes with him in his adventurous activities. The Inventor wanted to capture his pet's point of view and perspective. The only equipment that was on the market could only hold a device from the pets back. Unfortunately, the devices found all attached at the pets back which fails to capture the point of view of the pet as the head and neck obstruct the view of the recording device. It was because of this shortcoming in current devices that the Inventor decided to make a device that can capture the point of view of his dog as well as all other animals and make it adjustable as animals' heads range in different sizes.

Other head mounted applications are known in the prior art, but many of these applications, whether for animals such as canines, or humans, suffer from many of the same shortcomings. Commonly, they are difficult to wear, hard to adjust if there is even an adjustable feature or means and provide challenges to connect to the head and neck of the animal or person on which they are to be worn.

Therefore, what is needed is a new design for a device mount that can readily and easily be attached to a wearer, such as a canine, which has several means and locations for adjustability to enable proper securement to wearers of different sizes. While providing a mounting means enabled to engage one or more electronic device types, such as cameras, smart phone, or other portable electronic devices.

One of the main issues solved by the present invention compared to prior art designs is that the present invention has a unique multiple parallel and perpendicular adjustable straps which hook under the animal's ear in which whatever device is attached is unable to come off when an animal shakes its head.

### SUMMARY OF THE INVENTION

The device is comprised of a first and second parallel strap systems, connected by a central square or rectangular pad, and having a plurality of inner facing and complimentary loops on the inner side of the first and second parallel straps, providing for one or more adjustable perpendicular straps.

The first and second parallel straps are comprised of one end with an end loop and the other end having hook and loop fastener sections where the opposing end of the strap can be threaded through the loop end of the strap and the hook and loop fastener sections can be folded to engage each other to secure the opposing end to the loop. The first and second parallel straps are oriented in manner so that the loop end and hook and loop fastener end of each individual strap are oriented or facing in opposing directions such that when they are in use and wrapped around an animals head and neck area, the end loops and hook and loop fasteners are facing in opposing directions.

The central square or rectangular pad has an outer surface and a cushioned interior cavity which spreads out pressure from an attached device and the straps over a larger surface area of the wearing, resulting in increased comfort, support while reducing slippage and movement during wear. The top surface of the central square or rectangular pad is further comprised of an attached mount which provides connection means for attaching an electronic device such as a camera or smartphone.

The first and second parallel strap systems are further comprised of a plurality of inner facing and complimentary loops on the inner side of the first and second parallel straps, providing for one or more adjustable perpendicular straps. The inner facing complimentary loops on each opposing parallel strap provide adjustment means making the device adaptable to a variety of sizes and to provide better fitment by allowing these first and second parallel straps to be adjusted or fixed in length and movable to increase or decrease their distance from the center device mount to accommodate the ears of animals to which the device is intended to be attached. By adjusting the location and length of the first and second parallel straps, comfort, adaptability, and adjustment are provided.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is the perspective view of the head mount;

FIG. 2 is the front view of the head mount in FIG. 1;

FIG. 3 is the rear view of the head mount in FIG. 1;

FIG. 4 is the left side view of the head mount in FIG. 1;

FIG. 5 is the right side view of the head mount in FIG. 1;

FIG. 6 is the top view of the head mount in FIG. 1;

FIG. 7 is the bottom view of the head mount in FIG. 1; and

FIG. 8 is the functional view of the head mount in FIG. 1.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

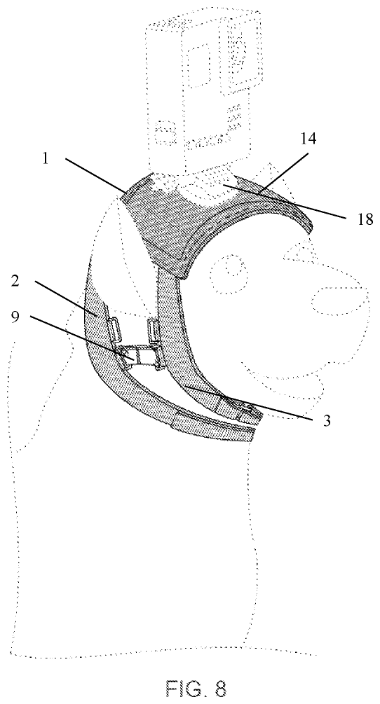

The device of the present invention is device mount. The device mount 1 of the present invention is directed to and intend to be worn by a canine animal as shown in FIG. 8 but could be readily adapted to any animal with a similar head and next structure.

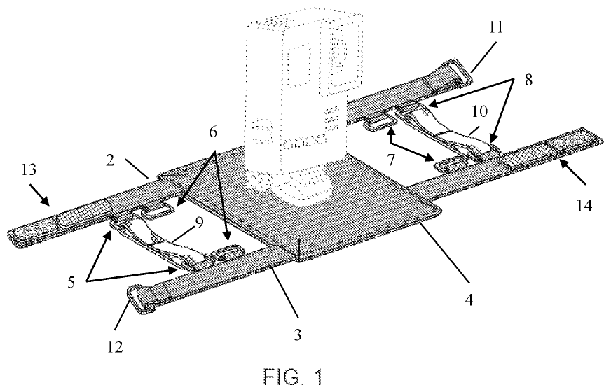

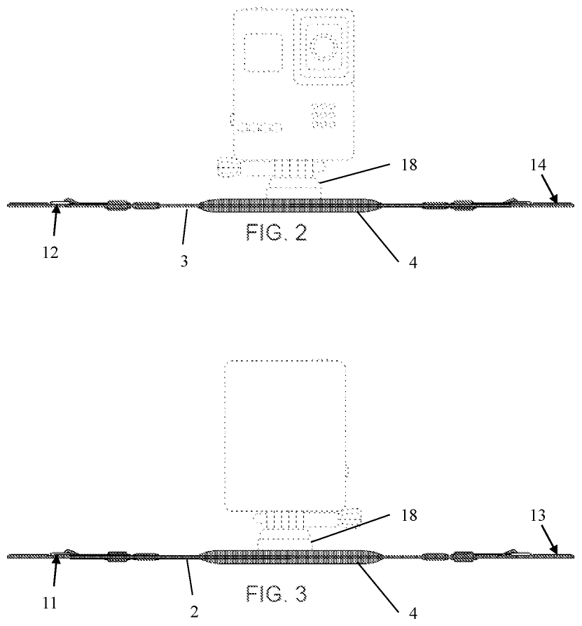

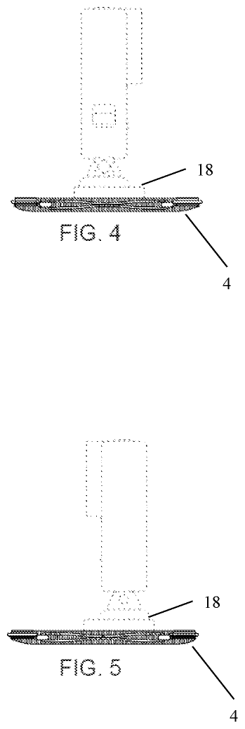

As shown in FIG. 1, the device is comprised of a first and second parallel strap systems 2 and 3, connected by a central square or rectangular pad 4, and having a plurality of inner facing and complimentary loops 5,6, 7, and 8 on the inner side of the first and second parallel straps, 2 and 3 providing for one or more adjustable perpendicular straps 9 and 10

The first and second parallel straps 2 and 3 are comprised of one end with an end loop 11 and 12 and the other end having hook and loop fastener sections 13 and 14 where the opposing hook and loop fastener end of the strap 13 and 14 can be threaded through the loop end 11 and 12 of the parallel straps 2 and 3 and the hook and loop fastener sections 13 and 14 can be folded to engage each other to secure the opposing hook and loop fastener end of the strap 13 and 14 to the end loop 11 and 12. The first and second parallel straps 2 and 3 are oriented in manner so that the loop end 11 and 12 and hook and loop fastener end 13 and 14 of each individual strap are oriented or facing in opposing directions such that when they are in use and wrapped around an animal's head and neck area, the end loops 11 and 12 and hook and loop fastener ends 13 and 14 are facing in opposing directions.

The orientation of the first and second parallel straps 2 and 3 and specific end features is important to decrease the likelihood that any forces acting on the mount, whether from the animal or externally (from being caught on snagged on an environmental feature) reduce the chances of the mount being completely removed from the wearers head and potentially lost and not merely loosened.

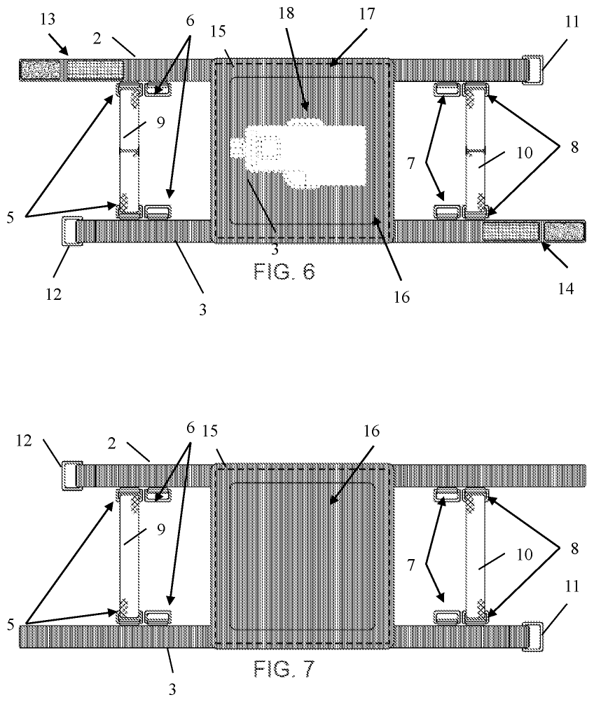

As shown in FIGS. 6 and 7, the central square or rectangular pad 4 has an outer surface 15 and a cushioned interior cavity 16 which spreads out pressure from an attached device and the straps 2 and 3 over a larger surface area of the wearing, resulting in increased comfort, support while reducing slippage and movement during wear. The top surface 17 of the central square or rectangular pad 4 is further comprised of an attached mount 18 which provides connection means for attaching an electronic device such as a camera or smartphone.

The bottom surface 19 of the central square or rectangular pad 4 could be alternatively covered in a non-slip or high frictional material to help reduce sliding of the mount when worn.

The first and second parallel strap systems 2 and 3 are further comprised of a plurality of inner facing and complimentary loops 5, 6, 7, and 8 on the inner side of the first and second parallel straps 2 and 3, providing for one or more adjustable perpendicular straps 9 and 10. The inner facing complimentary loops 5, 6, 7, and 8 on each opposing parallel strap 2 and 3 provide adjustment means making the device adaptable to a variety of sizes and to provide better fitment by allowing these first and second parallel straps 2 and 3 to be adjusted or fixed in length and movable to increase or decrease their distance from the center device mount 18 to accommodate the ears of animals to which the device is intended to be attached. By adjusting the location and length of the first and second parallel straps 2 and 3 by adjusting the length and location of the perpendicular straps 9 and 10, comfort, adaptability, and adjustment are provided.

The first and second perpendicular straps 9 and 10 can be made from elastic material, and can be of fixed length, or have an adjustable length using the same design as the parallel straps 2 and 3 in that the perpendicular straps 9 and 10 can be threaded through the inner facing complimentary loops 5, 6, 7, and 8 on each opposing parallel strap 2 and 3 and use a hook and loop fastener to secure them in place and to adjust distance and tension when worn.

In the embodiments illustrated, the perpendicular straps 9 and 10 are of a fixed length design with a center seam making them non-adjustable and non-movable. In alternative embodiments, the same hook and loop fastener ends 13 and 14 can be used as shown for the parallel straps 2 and 3 making the perpendicular straps easily and readily movable between complimentary loops 5, 6, 7, and 8 on the inner side of the first and second parallel straps 2 and 3 as well as adjustable for length.

One of the main issues solved by the present invention compared to prior art designs is that the present invention has these unique multiple adjustable perpendicular straps 9 and 10 which are configured to hook under the animal's ear and whatever device is attached is unable to come off when an animal shakes its head as the compression forces of the parallel straps 2 and 3 in combination with the perpendicular straps 9 and 10 provides far superior and sufficient attachment when configured to be worn on the head of a canine or similar animal of similar anatomy.

In an alternative embodiment, other features and designs allow devices to be attached to the sides of the device holder configured to be worn below the ears of the animal and may use quick release buckles for removable attachment of the devices.

In yet another embodiment, another feature integrates the parallel and/or the perpendicular straps with one or more built in IOT (Internet of Things) devices giving a more sleek look.

In the embodiment shown in the figures, the first and second perpendicular straps are shown being a fixed length/distance, which a strap material extended though each of the loops and secured with a center seem.

Thus, it is appreciated that the optimum dimensional relationships for the parts of the invention, to include variation in size, materials, shape, form, function, and manner of operation, assembly, and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A device mount apparatus, the apparatus comprising:
a first and second parallel strap;
a central square or rectangular pad;
the first and second parallel strap systems, connected by the central square or rectangular pad;
the first and second parallel straps having a plurality of inner facing and complimentary loops on the inner side of the first and second parallel straps, providing for one or more adjustable perpendicular straps;
the first and second parallel straps further comprised of one end with an end loop and the other end having hook and loop fastener sections where the opposing end of the strap can be threaded through the loop end of the strap and the hook and loop fastener sections can be folded to engage each other to secure the opposing end to the loop;
the top surface of the central square or rectangular pad is further comprised of an attached mount which provides connection means for attaching an electronic device such as a camera or smartphone.

2. The apparatus of claim 1, wherein
the first and second parallel straps are oriented in manner so that the loop end and hook and loop fastener end of each individual strap are oriented or facing in opposing directions such that when they are in use and wrapped around an animal's head and neck area, the end loops and hook and loop fasteners are facing in opposing directions.

3. The apparatus of claim 1, wherein
the central square or rectangular pad has an outer surface and a cushioned interior cavity

4. The apparatus of claim 1, wherein
the bottom surface of the central square or rectangular pad is covered in a non-slip or high frictional material.

5. The apparatus of claim 1, wherein
the first and second parallel strap systems are further comprised of a plurality of inner facing and complimentary loops on the inner side of the first and second parallel straps, providing for the attachment of one or more adjustable perpendicular straps.

6. The apparatus of claim 5, wherein
the inner facing complimentary loops on each opposing parallel strap provide adjustment means making the device adaptable to a variety of sizes and to provide better fitment;
the first and second parallel straps are adjusted or fixed in length and movable to increase or decrease their distance from the center device mount.

7. The apparatus of claim 5, wherein
the first and second perpendicular straps are made from elastic material.

8. The apparatus of claim 5, wherein
the first and second perpendicular straps are a fixed length.

9. The apparatus of claim 8, wherein
the strap material of the first and second perpendicular straps extended though each of the loops and secured with a center seem.

10. The apparatus of claim 5, wherein
the first and second perpendicular straps have an adjustable length wherein the strap can be threaded through the loops and use a hook and loop fastener to secure them in place and to adjust distance and tension when worn.

11. The apparatus of claim 1, wherein
one or more devices are attached to the sides of the device holder and are configured to be below the ears of an animal.

12. The apparatus of claim 11, wherein
quick release buckles are used to removably attached the one or more devices to the apparatus.

13. The apparatus of claim 1, wherein
the apparatus is configured to be worn by an animal.

14. The apparatus of claim 13, wherein
the animal is a canine.

15. The apparatus of claim 1, wherein
the parallel straps are further comprised of one or more built in TOT devices.

16. The apparatus of claim 1, wherein
the perpendicular straps are further comprised of one or more built in TOT devices.
